(19) United States
(12) Patent Application Publication
(10) Pub. No.: US 2010/0120312 A1
(43) Pub. Date: May 13, 2010

(54) Fiber Mat And Process Of Making Same

(76) Inventors: Linlin Xin, Wayne, NJ (US); Yaron Steinhauer, Valley Cottage, NJ (US); William Bittle, York, SC (US)

Correspondence Address: INTERNATIONAL SPECIALTY PRODUCTS;WILLIAM J. DAVIS, ESQ., 1361 ALPS ROAD, WAYNE, NJ, 07470, US

(21) Appl. No.: 12/373,424

(22) PCT Filed: Jul. 12, 2007
(86) PCT No.: PCT/US07/73316

§ 371 Date: Dec. 3, 2009

(30) Foreign Application Priority Data
Jul. 12, 2006 (US) 11485197

(51) Int. Cl. B32B 17/02; B32B 5/02

(52) U.S. Cl. 442/180; 442/59

(57) ABSTRACT

A fiber mat of improved hot wet tensile strength and a process of making same is disclosed. The fiber mat consists of fibers; a formaldehyde-free resinous fiber binder coating the fibers; and a binder-modifier which is a functional silane monomer or polymer.

### BACKGROUND OF THE INVENTION

1. Field of the Invention

The present invention relates generally to a fiber mat and a process of making the same, and, more particularly, to a glass fiber mat comprising fibers, a formaldehyde-free binder and a defined binder modifier. Embodiments of the present invention can have desired characteristics, such as, for example, improved hot wet tensile strength, as compared with a conventional mat where no such defined binder modifier is employed, and can be suitable for use in building materials.

2. Description of the Prior Art

High strength fiber mats have become increasingly popular in the building materials industry. Most commonly used in roofing shingles, fiber mats have numerous other material applications, including use in roofing, siding and floor underlayment; insulation facers; floor and ceiling tile; and vehicle parts.

Various fiber mats and methods of making same have been previously described utilizing formaldehyde-free binders. For example, U.S. Pat. Nos. 5,932,665, 6,114,464, 6,299,936, 6,136,916, 6,348,530, 4,135,029 and 6,642,299; and EP 1655400A1 and WO 2006/009823 A2; describe glass fiber mats made by a wet-laid process. Glass fiber mats made by the wet-laid process are formed from glass fibers held together by a binder material. Typically, in wet process glass fiber mats, the binder is applied in a liquid form and dispersed onto the glass fibers by a curtain type applicator. Conventional wet processes strive to produce a uniform coating of binder on the glass fibers. After the binder and glass fibers have been dried and cured, the glass fiber mat is then cut as desired.

A major problem in the manufacture and use of some known fiber mats is inadequate hot wet tensile strength. Inadequate hot wet tensile strength can cause interruption in roofing manufacture, and may reduce the ability of the finished roofing product to resist stresses during service on the roof. Because building materials, generally, and roofing shingles, in particular, are often subjected to a variety of weather conditions, the fiber mats must also maintain their strength characteristics under a wide range of conditions.

Similarly, high temperatures can affect shingle performance. The tensile strength over these temperature ranges may depend on the adhesion of the fibers to the fiber binder system, the mechanical properties of the binder system, and the interaction of the fiber mats with asphalt.

Various embodiments of the present invention may be suitable for use as a component of building materials, and other applications. Various embodiments may provide a material having improved tensile strength under a variety of conditions. In addition, the process of making fiber mats in accordance with some embodiments of the present invention may provide a fiber mat having improved hot wet tensile strength. Additional advantages of embodiments of the invention are set forth, in part, in the description which follows and, in part, will be apparent to one of ordinary skill in the art from the description and/or from the practice of the invention.

### SUMMARY OF THE INVENTION

Responsive to the foregoing challenges, Applicants have developed an innovative fiber mat for use in a building material, the mat comprising:
about 55% w/w to 99.5% w/w, and preferably 72% w/w to 98% w/w of fibers; and
about 0.05% w/w to 45% w/w, and preferably 2% w/w to 28% w/w of a formaldehyde-free binder which coats the fibers, and
0.1% w/w to 20% w/w, and preferably 0.5% w/w to 10% w/w, of a binder modifier which is a functional silane monomer or polymer, based on the weight of the binder, or the binder to the functional silane is about 1000:1 to 4:1, and, preferably, about 200:1 to 9:1.

Applicants have developed an innovative process of making a fiber mat for use in a building material, the process comprising the steps of: (a) forming an aqueous fiber slurry; (b) removing water from the fiber slurry to form a wet fiber mat; (c) saturating the wet fiber mat with an aqueous solution of a fiber binder; (d) spraying the wet fiber mat with a binder modifier and (e) drying and curing the wet fiber mat to form a fiber mat product. In one embodiment, the fiber binder and the binder modifier may be mixed together and applied in a single step.

It is to be understood that both the foregoing general description and the following detailed description are exemplary and explanatory only, and are not restrictive of the invention as claimed.

### DETAILED DESCRIPTION OF EMBODIMENTS OF THE INVENTION

In suitable embodiments of the present invention the formaldehyde-free binder is ACRODUR® DS-3558 resin binder (styrene-acrylate dispersion modified with polycarboxylic acid and a polyol as the crosslinking agent) supplied by BASF was used. The individual glass fiber parts were soaked in the binder solution under ambient conditions after which excess solution was removed under vacuum to provide binder wet mats containing about 6-62%% w/w fibers, 8-10% w/w binder, and about 30% w/w water.

The fiber binder may comprise between about 5 wt. % and about 30 wt. %, based on the fiber mat product weight.

The functional silane monomer or polymer which is the binder modifier of the invention contains a functional group which can couple with the resinous fiber binder material, Suitable functional silanes include amino silanes, vinyl silanes, methacryloxy silanes, mercaptosilanes, and epoxy silanes.

Examples of such functional silane monomers and polymers thereof, include gamma-aminopropyltrialkoxysilanes, gamma-isocyanatopropyl-triethoxysilane, vinyl-trialkoxysilanes, glycidoxypropyltrialkoxysilanes and ureidopropyltrialkoxysilanes, such as A-187 gamma-glycidoxy-propyltrimethoxysilanes, A-174 gamma-methacryloxypropyltrimethoxysilane, A-1100 gamma-aminopropyl-triethoxysilane, A-1108 amino silane and A-1160 gamma-ureidopropyl-triethoxysilane (each of which are commercially available from OSi Specialties, Inc. of Tarrytown, N.Y.).

Amino silane, monomers and polymers have been found to be particularly effective binder modifiers, e.g. trimethoxysilylpropyldiethylene-triamine, N-methylaminopropyltrimethoxysilane, aminoethylaminopropylmethyldimethoxysilane, aminoethylaminopropyltrimethoxysilane (Dow Corning Z-6020), a homopolymer of an amino silane (Dow Corning Z-6137), aminopropylmethyldimethoxysilane, aminopropyltrimethoxysilane, polymeric aminoalkylsilicone, aminoethylaminoethylaminopropyl-trimethoxysilane, N-methylaminopropyltrimethoxysilane, methylamino-propyltrimethoxysilane, aminopropylmethyldimethoxysilane, aminopropyltriethoxysilane, 4-aminobutyltriethoxysilane, and oligomeric aminoalkylsilane and the like, which are available from Dow Corning, Midland, Mich., Union Carbide Specialty Chemicals Division, Danbury Connecticut and Huls of America, Piscataway, N.J., Wacker Silicones Corporation of Adrian, Mich.

The formaldehyde-free fiber binder and the binder modifier are adapted to be compatible. The components may be intimately admixed in an aqueous medium to form a stable emulsion which may not become overly gummy, or gel, even after storage for periods of 24 hours or longer. This may be advantageous in practical commercial use of the composition. It is contemplated that individual aqueous mixtures for binder and modifier may be used in embodiments of the present invention.

In one embodiment of the present invention, the fibers comprise glass fibers. The glass fibers may comprise individual fiber filaments having an average length in the range of, but not limited to, from about ¼ inch to about 3 inches, and an average diameter in the range of, but not limited to, from about 5 to about 50 micrometers (μm). It is contemplated, however, that the glass fibers may be in another form, such as, for example, a continuous strand or strands. In an alternative embodiment of the present invention, the fibers may comprise other fibers, including, but not limited to, wood, polyethylene, polyester, nylon, polyacrylonitrile, and/or a mixture of glass and one or more other fibers. In one embodiment, the fiber mat may further comprise a small amount of filler, e.g. less than about 0.5%, based on the fiber weight. A fiber mixture may be optional for construction material application, such as, for example, roofing and siding, because excessive amounts of filler may reduce porosity and vapor ventability of the fiber mat.

In the finished cured mat product, the fiber content may be in the range of from about 55 wt. % to about 98 wt. %. In one embodiment of the present invention, the fiber content is more particularly in the range of from about 66 wt. % and about 88 wt. %. The binder content may be in the range of from about 0.05 wt. % to about 45 wt. %. In one embodiment of the present invention, the binder content is more particularly in the range of from about 15 wt. % to about 30 wt. %.

In one embodiment of the present invention, the fibers may be formed into a mat with the aid of a dispersing agent. The fiber dispersing agent may comprise, for example, tertiary amine oxides (e.g. N-hexadecyl-N,N-dimethyl amine oxide), bis(2-hydroxyethyl) tallow amine oxide, dimethyl hydrogenated tallow amine oxide, dimethylstearyl amine oxide and the like, and/or mixtures thereof. As will be apparent to those of ordinary skill in the art, other known dispersing agents may be used without departing from the scope and spirit of the present invention. The dispersing agent may comprise a concentration in the range of from about 10 ppm to about 8,000 ppm, based on the amount of fiber. The dispersing agent may further comprise a concentration in the range of from about 200 ppm to about 1,000 ppm, based on the amount of fiber.

In one embodiment, the fibers may be formed into a mat with the aid of one or more viscosity modifiers. The viscosity modifier may be adapted to increase the viscosity of the composition such that the settling time of the fibers is reduced and the fibers may be adequately dispersed. The viscosity modifier may include, but is not limited to, hydroxyl ethyl cellulose (HEC), polyacrylamide (PAA), and the like. As will be apparent to those of ordinary skill in the art, other viscosity modifiers may be used without departing from the scope and spirit of the present invention.

The process of making a fiber mat in accordance with one embodiment of the present invention will now be described. The process will be described with particular reference to a wet-laid process. It is contemplated, however, that other processes known in the art, such as, for example, a dry-laid process, may be used without departing from the scope and spirit of the present invention. Furthermore, the process is described using chopped bundles of glass fibers. As discussed above, however, other types of fiber content are considered well within the scope of the present invention.

The process of forming glass fiber mats according to one embodiment of the present invention comprises adding chopped bundles of glass fibers of suitable length and diameter to an aqueous medium to form an aqueous fiber slurry. As discussed above, the aqueous medium may include a suitable dispersing agent. A viscosity modifier or other process aid may also be added to the water/dispersing agent medium. From about 0.05 to about 0.5 wt. % viscosity modifier in white water may be suitably added to the dispersant to form the slurry.

The glass fibers may be sized or unsized, and may be wet or dry, as long as they are capable of being suitably dispersed in the water/dispersing agent medium. The fiber slurry, containing from about 0.03 wt. % to about 8 wt. % solids, is then agitated to form a workable dispersion at a suitable and uniform consistency. The fiber slurry may be additionally diluted with water to a lower fiber concentration to between about 0.02 wt. % and about 0.08 wt. %. In one embodiment, the fiber concentration may be more particularly diluted to about 0.04 wt. % fiber. The fiber slurry is then passed to a mat-forming machine such as a wire screen or fabric for drainage of excess water. The excess water may be removed with the assistance of vacuum.

The fibers of the slurry are deposited on the wire screen and drained to form a fiber mat. The fiber mat may then be saturated with an aqueous solution of binder. The aqueous binder solution may comprise, for example, from about 10 wt. % to about 40 wt. % solids. The fiber mat may be soaked for a period of time sufficient to provide the desired fixative for the fibers. Excess aqueous binder solution may then be removed, preferably under vacuum.

The formed fiber mat may then be sprayed with the binder modifier to achieve the desired concentration. An aqueous solution of the modifier may be used to obtain a uniform distribution over the binder treated fibers. In one embodiment of the present invention, either before or after applying the binder modifier, the fiber mat may be compressed, for example by passing it between rollers or another compressing device, to reduce mat thickness for curing. In addition to spraying, this invention also contemplates neutralizing the acid with a base such as ammonia and adding it into binder solution to avoid gelling. It is believed that the ammonia will volatize at high curing temperature and the acid form will return.

After treatment with binder and binder-modifier composition, the mat is then dried and the fixative composition may be cured in an oven at an elevated temperature. A temperature in the range of about 160° C. to about 400° C., for at least about 2 seconds, may be used for curing. In one embodiment, a cure temperature in the range of about 225° C. to about 350° C. may be used, It is contemplated that in an alternative embodiment of the present invention, catalytic curing may be provided with an acid catalyst, such as, for example, ammonium chloride, p-toluene sulfonic acid, or any other suitable catalyst.

The combination of the modified emulsion and binder used in various embodiments of the present invention may provide several advantages over current binder compositions. For example, the tensile strength of the mat may be increased. In addition, the tensile strength of the mat may be increased at lower temperatures to minimize cracking and failure. Other advantages will be apparent to one of ordinary skill in the art from the above detailed description and/or from the practice of the invention.

Having generally described various embodiments of the present invention, reference is now made to the following example which illustrates embodiments of the present invention and comparisons to a control sample. The following examples serve to illustrate, but are not to be construed as limiting to, the scope of the invention as set forth in the appended claims.

### Preparation of Glass Mat

Part A. In a 20 liter vessel at room temperature, under constant agitation, 5.50 g of chopped bundles of glass fibers, having an average 20-40 mm length and 12-20 micron diameter, were dispersed in 12 liters of water containing 800 ppm of N-hexadecyl-N,N-dimethylamine oxide to produce a uniform aqueous slurry of 0.04 wt. % fibers. The fiber slurry was then passed onto a wire mesh support with dewatering fabric, and a vacuum was applied to remove excess water and to obtain a wet mat containing about 60% fibers.
Part B. Aqueous samples of 10 wt. % solids containing ACRODUR® DS-3558 resin binder (styrene-acrylate dispersion modified with polycarboxylic acid and a polyol as the X-linking agent) supplied by BASF and a binder modifier which was Dow Corning Z-6137 Silane supplied by Dow Corning Corp. was prepared and applied to individual samples of wet glass mats prepared by the procedure in Part A. The individual wet glass mats were soaked in the binder/modifier solution under ambient conditions after which excess solution was removed under vacuum to provide binder wet mats containing 63 wt. % glass fibers, 7 wt. % binder and 30 wt. % water.
Part C. For comparison purposes, Control samples were prepared as described in Parts A and B except that the UF binder, HexionFG607A, supplied by Hexion Specialty Chemcials, was used alone or with OmnovaGenflo3112 latex, i.e. a carboxylated styrene-butadiene copolymer latex supplied by Omnova Solutions Inc.
Part D. For comparison purposes, Control-B samples were prepared as described in Parts A and B except that formaldehyde-free resin, ACRODUR® DS-3558 was used without the addition of Dow Corning's Z6137 Silane binder-modifier.
Part E. The mat samples made according to Parts A and B were dried and cured for 8 seconds at 225° C. to obtain dry glass mats weighing about 79 g/m² and having a Loss on Ignition (LOI) of about 10%.
Part F. The mat samples made according to Part C were dried and cured for 8 seconds at 285° C. to obtain dry glass mats weighing about 92 g/m² and having a Loss on Ignition (LOI) of about 19%.
Part G. The mat samples made according to Parts A and D were dried and cured for 8 seconds at 225° C. to obtain dry glass mats weighing about 89 g/m² and having a Loss on Ignition (LOI) of about 9%.
Part H. After the cure, the mat hot wet tensile strength was measured in the following way. The 50 mm×200 mm cured mat strip was soaked in a 80° C. water bath for 10 minutes, then blotting paper was used to remove the excess water on the wet mat strip. The wet tensile of the mat strip was measured on an Instron Tensile Tester. The percent of hot wet tensile retention was determined by dividing the wet tensile by the dry tensile of the mat sample that was not soaked in the water bath. % Hot Wet Tensile=(Wet Tensile Average/Dry Tensile Average)×100.

The results of these tests are given in the Tables 1 and 2 below.

TABLE 1
Binder Compositions

| | | | Invention |
|---|---|---|---|
| Ingredient | Control-A | Control-B | Example |
| Binder | Hexion | ACRODUR ® | ACRODUR ® |
| | FG607A | DS-3558 | DS-3558 |
| Binder | Urea- | Styrene-acrylate | Styrene-acrylate |
| Chemistry | Formaldehyde | dispersion | dispersion |
| | Resin | modified with | modified with |
| | | polycarboxylic | polycarboxylic |
| | | acid and a polyol | acid and a |
| | | as the | polyol as the |
| | | crosslinking | crosslinking |
| | | agent | agent |
| Modifier | Omnova | N/A | Dow Corning |
| | Genflo3112 | | Z6137 |
| Modifier | Carboxylated | N/A | Homopolymer of |
| Chemistry | Styrene | | an |
| | Butadiene | | Aminofunctional |
| | Copolymer | | Silane |
| Binder/Modifier | 99/1 | 100/0 | 99.5/0.5 |
| (w/w) | | | |

TABLE 2
Mat Properties

| | | | Invention | Changed % |
|---|---|---|---|---|
| Property | Control-A | Control-B | Example | over Control |
| Mat Basis | 92 | 89 | 79 | — |
| Weight (gms) | | | | |
| Mat LOI % | 19 | 9 | 10 | — |
| Curing | 285 C./8 | 225 C./8 sec | 225 C./8 sec | — |
| | sec | | | |
| % Hot Wet Mat | 61 | 59 | 99 | +65 |
| Tensile | | | | |

The results show a significant increase in % Hot Wet Mat Tensile Strength for the Invention Example over Control samples.

It will be apparent to those skilled in the art that various other modifications and variations can be made in the construction, configuration, and/or operation of the present invention without departing from the scope or spirit of the invention. Embodiments of the fiber mat may be used in the building material including but not limited to, shingles, underlayment, insulation facers, floor and ceiling tile, vehicle parts, and/or any other suitable building material. Thus, it is intended that that present invention cover all such modifications and variations of the invention, provided they come within the scope of the appended claims and their equivalents.

What is claimed is:

1. A formaldehyde-free fiber mat for use in a building material, said fiber mat comprising:
55% w/w to 99.5% w/w of a plurality of fibers; and
0.05% w/w to 45% w/w of a formaldehyde-free resinous binder coating said fibers,
and a fiber binder-modifier wherein said fiber binder-modifier is a functional silane monomer or polymer, wherein the wt. ratio of binder:modifier is 1000:1 to 4:1.

2. The fiber mat of claim 1 wherein said fiber binder:modifier wt. ratio is about 200:1 to 9:1.

3. A formaldehyde-free glass fiber mat according to claim wherein said fiber binder-modifier is an aminofunctional silane.

4. The glass fiber mat of claim 3 wherein the concentration of said fibers is 55% to about 98% w/w.

5. The glass fiber mat of claim 4 having increased hot wet mat tensile strength.

6. The glass fiber mat of claim 1 wherein said binder is a styrene-acrylate suspension modified with polycarboxylic acid and a polyol as the cross-linking agent.
